(19) United States
(12) Patent Application Publication
(10) Pub. No.: US 2014/0000835 A1
(43) Pub. Date: Jan. 2, 2014

(54) LOW VOID FRACTION THERMAL STORAGE ARTICLES AND METHODS

(71) Applicant: Saint-Gobain Ceramics & Plastics, Inc., Worcester, MA (US)

(72) Inventors: Hassan S. NIKNAFS, Stow, OH (US); Daniel C. SHERMAN, Hudson, OH (US); Thomas SZYMANSKI, Hudson, OH (US)

(21) Appl. No.: 13/925,886

(22) Filed: Jun. 25, 2013

Related U.S. Application Data
(60) Provisional application No. 61/665,957, filed on Jun. 29, 2012.

(51) Int. Cl. F28D 20/00; F28D 15/00; B23P 11/00

(52) U.S. Cl. CPC F28D 20/0056; B23P 11/00; F28D 15/00
USPC 165/10; 29/428; 165/104.28

(57) ABSTRACT

Low void fraction thermal energy storage articles, systems, and methods for making and using such thermal energy storage articles and systems. Thermal energy storage units include a thermal energy storage body having a particular void volume and a mixing cavity-creating element. Thermal energy storage modules include two or more thermal energy storage bodies arranged adjacently with an intervening cavity defined by a cavity-creating element. The total void volume of a thermal energy storage module (i.e., the sum of the void volume of the passages of the thermal energy storage bodies and the cavity) is between about 10% and about 40%.

### CROSS-REFERENCE TO RELATED APPLICATION

This application claims the benefit of U.S. Provisional Application No. 61/665,957 filed Jun. 29, 2012.

### BACKGROUND

1. Field of the Disclosure

The present disclosure is generally directed to low void fraction thermal energy storage articles, systems, and methods for making and using such thermal energy storage articles and systems.

2. Description of the Related Art

Energy storage of all types plays an important role in energy conservation. The efficient collection, use, and conservation of thermal energy, such as solar energy or waste heat from industrial processes, are an important aspect of energy development and energy management. In particular, storage of thermal energy in the form of sensible and latent heat is important.

There has been intense interest in the ability to efficiently store and retrieve large amounts of thermal energy (i.e., heat energy). Thermal storage technology exists that can recover, store, and withdraw heat energy, including natural energy such as solar thermal energy, terrestrial heat (e.g., volcanic, hydrothermal, etc.), and artificially produced heat energy such as industrially generated waste heat. Thermal energy storage systems can be broadly classified into sensible heat systems, latent heat systems, and bond energy systems. Sensible heat systems are those which store thermal energy by heating a medium, typically a liquid or a solid, without any change of phase. Latent heat systems are those which heat a medium that undergoes a phase change (usually melting). Bond energy storage systems are those which store thermal energy by having a medium undergo an endothermic-exothermic reaction that converts the thermal energy into chemical energy.

Thermal energy storage improves performance of energy systems by smoothing supply and increasing reliability. Although solar energy is an abundant, clean, and safe source of energy, it suffers from yearly and diurnal cycles; thus necessarily being intermittent, and often is unpredictable and diffused due to variable weather conditions (e.g., rain, fog, dust, haze, cloudiness). Further, the demand for energy is also unsteady; following yearly and diurnal cycles for both industrial and consumer needs. Therefore there continues to be a demand for improved, cost effective articles, processes, and systems that promote efficient storage, recovery, and usage of thermal energy.

### BRIEF DESCRIPTION OF THE EMBODIMENTS

A thermal energy storage unit of the present invention generally includes a thermal energy storage body having a top surface, a bottom surface, a plurality of perforations that form passages extending through the thermal energy storage body from the top surface to the bottom surface. The thermal energy storage body of the thermal energy storage unit may also include an attached mixing cavity-creating element. Alternatively, the mixing cavity-creating element may be a separate unit used in conjunction with the thermal energy storage body when employed in a thermal energy storage system.

The thermal energy storage body includes perforations, or openings, in the top and bottoms surfaces. Perforations define an average hydraulic diameter D_{Havg}, wherein particular embodiments of perforations include 1-2 perforations/in² (1-2 perforations/6.452 cm²) with any particular perforation having an upper limit D_{Havg}=1 in (6.452 cm) The perforations also define an average wall thickness Thk_{avg} as the narrowest interior wall thickness between adjacent perforations, wherein particular embodiments include D_{Havg}/Thk_{avg}=0.5−3.0.

The thermal energy storage body perforations also define passages, which may have shapes that are uniform, irregular, or any combination thereof, as they extend through the thermal energy storage body.

The thermal energy storage body perforations also define an open face void as a percentage of the diameter of the perforations to the total face surface area. The thermal energy storage body perforations also define a void volume as the percent of the void of the passages with respect to the total area of the thermal energy storage body, wherein particular embodiments include a void volume range between about 10% to about 35%.

An arrangement of two or more bodies and an intervening cavity defines a module, where the bodies are arranged adjacent together with a cavity in between the bodies, wherein the bodies are arranged such that the passages direct the flow of fluid through the bodies and the intervening cavity. The module includes a total void volume, wherein the sum of the void volume of the individual bodies and of the cavity is in a range of between about 10% and about 40%.

The cavity is created by a cavity creating element, which may be a protrusion or a member that is integral with one or more surfaces of a thermal energy storage body, separate or external to the bodies, or extending from a containment vessel in which the bodies are disposed.

The thermal energy storage unit and module operation to control the flow of a fluid within the containment vessel. In doing so, heat from the fluid may be transferred to the one or more thermal energy storage bodies in one operation and stored heat from the thermal energy storage bodies may be transferred to the fluid in another operation.

### BRIEF DESCRIPTION OF THE DRAWINGS

The present disclosure may be better understood, and its numerous features and advantages made apparent to those skilled in the art by referencing the accompanying drawings.

FIG. 1 is an illustration of an embodiment of a thermal energy storage unit comprising a thermal energy storage body having an integral cavity-creating element (e.g., integral lip).

FIG. 2 is an illustration of a thermal storage module comprising two thermal energy storage bodies and an external cavity-creating element (a spacer ring).

FIG. 3A-3F are illustrations of cross-sections of alternate embodiments of thermal energy storage bodies having different shaped passages (e.g., circular, cross, straight slits, arcurate, S-shaped slits, and squares).

FIG. 4A-4C are illustrations of cross-sections of alternate embodiments of thermal energy storage bodies having passages arranged in different patterns (e.g., aligned multi-row array, non-aligned multi-row array, and radial).

FIG. 5A-5C are illustrations of thermal energy storage bodies having alternate embodiments of integral cavity-creating elements (e.g., multiple protrusions, raised strips, single protrusion).

FIG. 6A-6C are illustrations of a thermal energy storage unit having different integral cavity-creating elements on the top surface and bottom surface of the thermal energy storage body.

FIG. 7A-7C are illustrations of a thermal energy storage bodies having alternate embodiments of external cavity-creating elements (e.g., multiple separable protrusions, multiple separable raised strips, single separable raised protrusion).

FIG. 8 is an illustration of a thermal energy storage unit having a thermal energy storage body comprised of multiple pie-shaped pieces arranged together.

FIG. 9 is an illustration of alternate embodiment of a thermal energy storage unit comprised of concentric circular pieces.

FIG. 10 is a flow diagram for a process of making a ceramic thermal energy storage body.

The use of the same reference symbols in different drawings indicates similar or identical items.

### DETAILED DESCRIPTION OF THE EMBODIMENT(S)

The following description, in combination with the figures, is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

Inventive embodiments are described herein that are directed to thermal energy storage media that can be used in large scale thermal energy storage apparatus, such as those associated with solar powered energy generators. Particular inventive embodiments are directed to structured, modular, monolithic thermal energy storage media. The thermal energy storage media can be disposed within a container, such as a large pipe or containment vessel. A heat transfer fluid that has been charged (i.e., heated), such as by the sun, can be made to flow over and through the thermal energy storage media. The thermal energy storage media in turn absorbs heat from the heat transfer fluid and stores the absorbed thermal energy for later use. For instance, during periods when a solar powered collector cannot provide a sufficient quantity of heated fluid directly to a generator (such as at night), heat transfer fluid can be flowed through the heated thermal energy storage media so that the heat transfer fluid absorbs the stored heat and then transfers the heat to the generator where it can be used, for example, to generate steam.

Particular inventive embodiments are described herein that are directed to a thermal energy storage unit, a thermal energy storage module, and a thermal energy storage system. As described in greater detail below, the thermal energy storage unit is comprised of a thermal energy storage body and a mixing cavity-creating element. The thermal energy storage module is comprised of at least two thermal energy storage bodies that are separated by a mixing cavity-creating element. The thermal energy storage system comprises a plurality of thermal energy storage modules.

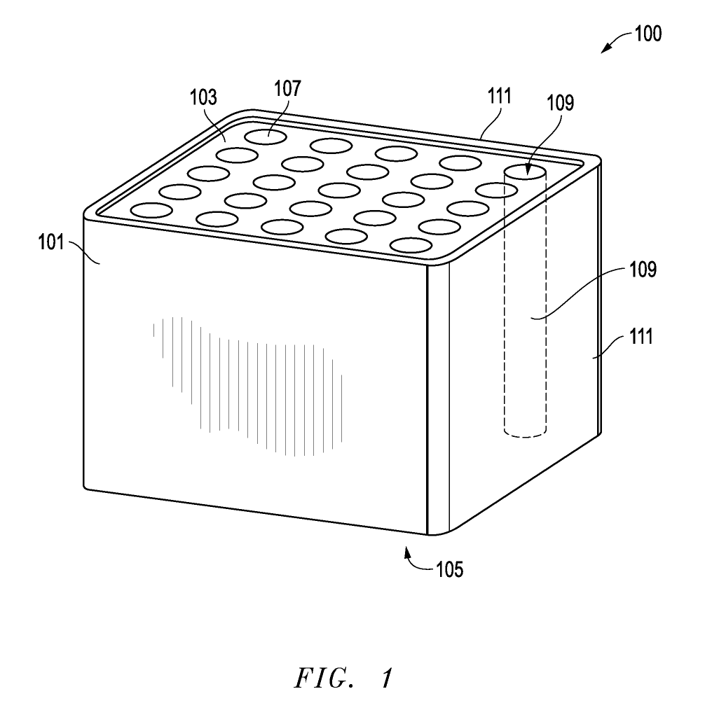

In an embodiment, as shown in FIG. 1, a thermal energy storage unit 100 comprises: a thermal energy storage body 101 having a top surface 103, a bottom surface 105, a plurality of perforations 107 that form passages 109 extending through the thermal energy storage body from the top surface 103 to the bottom surface 105, and a void volume in a range of about 10% to about 35%; and a mixing cavity-creating element 111.

The thermal storage properties of the thermal storage unit are influenced by the shape and dimensions of the thermal storage unit. The thermal energy storage unit has notable shape and dimensions of length, width, and height. The thermal energy storage body of the thermal energy unit can be any shape that has a top surface and a bottom surface and that has overall dimensions that allow it to fit within a containment vessel (not shown). In an embodiment, the length and width of the thermal energy storage body are sized to be substantially equal to the interior length and width of the containment vessel. In another embodiment, the thermal energy storage body can be smaller than the interior length and width of the containment vessel (such as for large containment vessels), such that multiple thermal energy storage bodies can be arranged side by side to fit within the containment vessel.

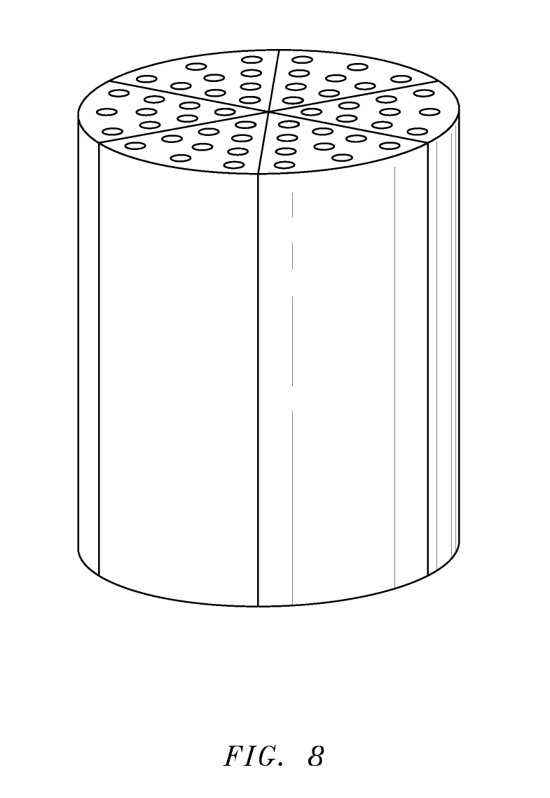

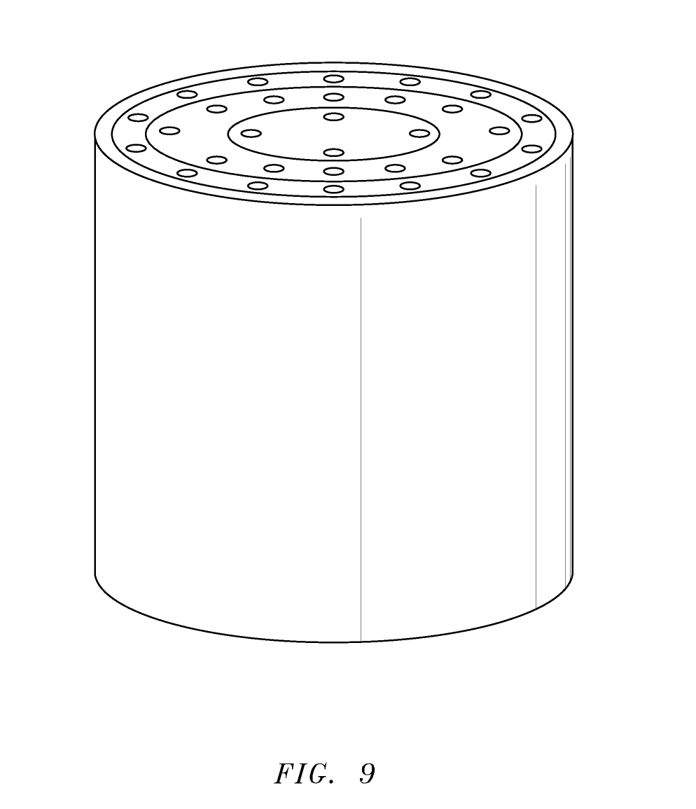

In an embodiment, the thermal energy storage body can be a unitary member. In an embodiment, the thermal energy storage body can comprise a plurality of pieces that fit together to form the thermal energy storage body, wherein the plurality of pieces can comprise a single layer. FIG. 8 illustrates a thermal energy storage body formed from a single layer of a plurality of pie-shaped wedge pieces. FIG. 9 illustrates a thermal energy storage body formed from a plurality of concentric shaped pieces.

In an embodiment, the thermal energy storage body can have a length dimension in a range of not greater than about 60 inches (152.4 cm), such as a length not greater than about 48 inches (121.92 cm), not greater than about 36 inches (91.44 cm), not greater than about 24 inches (60.96 cm), not greater than about 20 inches (50.8 cm), not greater than about 18 inches (45.72 cm), not greater than about 12 inches (30.48 cm), not greater than about 10 inches (25.4 cm), not greater than about 8 inches (20.32 cm), or not greater than about 6 inches (15.24 cm). In an embodiment, the length dimension can be not less than about 2 inches (5.08 cm), not less than about 3 inches (7.62 cm), not less than about 4 inches (10.16 cm), or not less than about 5 inches (12.7 cm). The length dimension can be within a range comprising any pair of the previous upper and lower limits. In a particular embodiment, the length dimension can be in the range of not less than about 4 inches (10.16 cm) to not greater than about 12 inches (30.48 cm), such as not less than about 5 inches (12.7 cm) to not greater than about 10 inches (25.4 cm).

In an embodiment, the thermal energy storage body can have a width dimension in a range of not greater than about 60 inches (152.4 cm), such as a width not greater than about 48 inches (121.92 cm), not greater than about 36 inches (91.44 cm), not greater than about 24 inches (60.96 cm), not greater than about 20 inches (50.8 cm), not greater than about 18 inches (45.72 cm), not greater than about 12 inches (30.48 cm), not greater than about 10 inches (25.4 cm), not greater than about 8 inches (20.32 cm), or not greater than about 6 inches (15.24 cm). In an embodiment, the width dimension can be not less than about 2 inches (5.08 cm), not less than about 3 inches (7.62 cm), not less than about 4 inches (10.16 cm), or not less than about 5 inches (12.7 cm). The width dimension can be within a range comprising any pair of the previous upper and lower limits. In a particular embodiment, the width dimension can be in the range of not less than about 4 inches (10.16 cm) to not greater than about 12 inches (30.48 cm), such as not less than about 5 inches (12.7 cm) to not greater than about 10 inches (25.4 cm).

In an embodiment, the thermal energy storage body can have a height dimension in a range of not greater than about 60 inches (152.4 cm), such as a height not greater than about 48 inches (121.92 cm), not greater than about 36 inches (91.44 cm), not greater than about 24 inches (60.96 cm), not greater than about 20 inches (50.8 cm), not greater than about 18 inches (45.72 cm), not greater than about 12 inches (30.48 cm), not greater than about 10 inches (25.4 cm), not greater than about 8 inches (20.32 cm), or not greater than about 6 inches (15.24 cm). In an embodiment, the height dimension can be not less than about 2 inches (5.08 cm), not less than about 3 inches (7.62 cm), not less than about 4 inches (10.16 cm), or not less than about 5 inches (12.7 cm). The height dimension can be within a range comprising any pair of the previous upper and lower limits. In a particular embodiment, the height dimension can be in the range of not less than about 4 inches (10.16 cm) to not greater than about 12 inches (30.48 cm), such as not less than about 5 inches (12.7 cm) to not greater than about 10 inches (25.4 cm).

In a particular embodiment, the dimensions of length, width, and height are 6 inches (15.24 cm) by 6 inches (15.24 cm) by 12 inches (30.48 cm) (6″×6×12″) (15.24 cm×15.24 cm×30.48 cm).

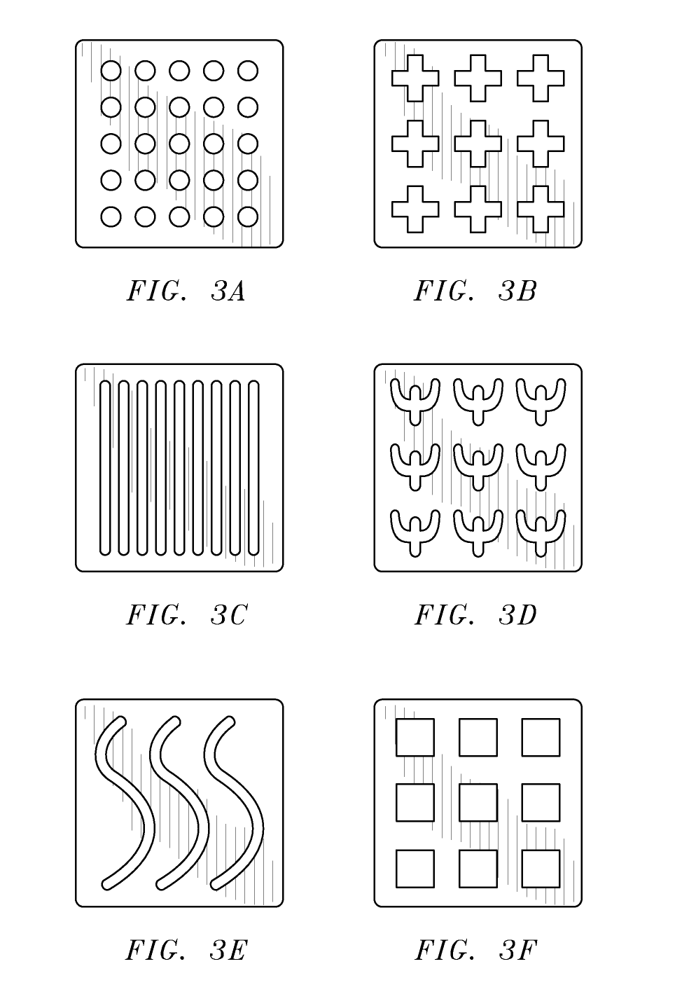

The void volume of the thermal energy storage unit can be influenced by the size, shape, and arrangement of the perforations (also called apertures, holes, openings, or voids) that are located on the top and bottom surfaces of the thermal energy storage body. The shape of the perforations can be regular or irregular. In an embodiment, the shape of the perforations can be in the form of slits, regular polygons, irregular polygons, ellipsoids, circles, arcs, crosses, spirals, channels, or combinations thereof. In a particular embodiment, the perforations have the shape of a circle. In another embodiment, the shape of the perforation may be in the form of one or more slits, wherein multiple slits can intersect, such as in the form of a cross or star. In another embodiment, the perforations are arcurate shaped. FIG. 3A-3F show examples of various shaped perforations.

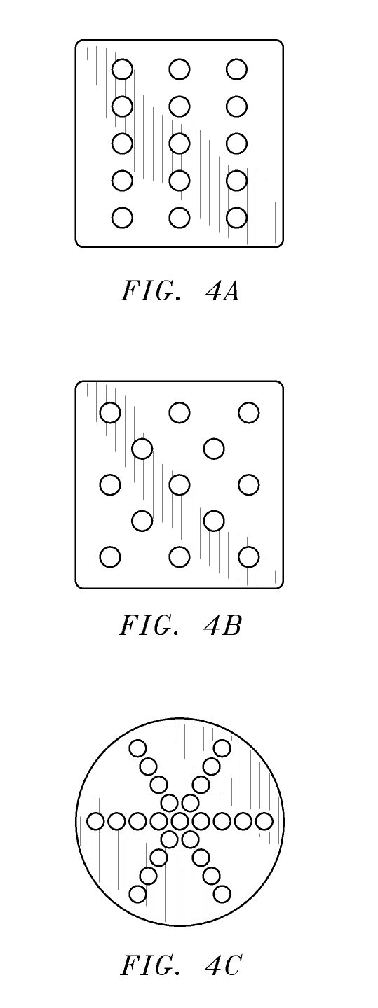

The concentration of the perforations on the top and bottom surfaces of the thermal energy storage body can be uniform or irregular. FIG. 4A shows a uniform concentration of perforations. FIG. 4C shows an irregular concentration of perforations. In an embodiment, the top or bottom surface of a thermal energy storage body can have a concentration of perforations in a range of not greater than about 5 perforations per square inch (per 6.452 square cm), such as not greater than about 4 perforations per square inch (per 6.452 square cm), not greater than about 3 perforations per square inch (per 6.452 square cm), not greater than about 2.5 perforations per square inch (per 6.452 square cm), not greater than about 2.2 perforations per square inch (per 6.452 square cm), not greater than about 2.0 perforations per square inch (per 6.452 square cm), not greater than about 1.9 perforations per square inch (per 6.452 square cm), not greater than about 1.8 perforations per square inch (per 6.452 square cm), or not greater than about 1.7 perforations per square inch (per 6.452 square cm). In an embodiment, the top or bottom surface of a thermal energy storage body can have a concentration of perforations in a range of not less than about 0.25 perforations per square inch (per 6.452 square cm), such as not less than about 0.5 perforations per square inch (per 6.452 square cm), not less than about 0.8 perforations per square inch (per 6.452 square cm), or not less than about 1.0 perforations per square inch (per 6.452 square cm). The concentration of perforations can be within a range comprising any pair of the previous upper and lower limits. In a particular embodiment, the concentration of perforations can be in the range of not less than about 0.5 perforations per square inch (per 6.452 square cm) to not greater than about 3.0 perforations per square inch (per 6.452 square cm), such as not less than about 1.0 perforation per square inch (per 6.452 square cm) to not greater than about 2.0 perforations per square inch (per 6.452 square cm).

The perforations of the thermal energy storage body have a notable hydraulic diameter. The hydraulic diameter can be useful to characterize certain dimensional and structural features of the embodiments of the thermal energy storage unit, particularly with regard to the thermal energy storage body and the cavity-creating element. The hydraulic diameter of the individual perforations can be uniform or varying, the same or different. In an embodiment, the average hydraulic diameter of the perforations can be in a range of not greater than about 2.0 inches (5.08 cm), such as not greater than about 1.8 inches (4.572 cm), not greater than about 1.6 inches (4.064 cm), not greater than about 1.4 inches (3.556 cm), not greater than about 1.2 inches (3.048 cm), or not greater than about 1.0 inches (2.54 cm), not greater than about 0.9 inches (2.286 cm). In an embodiment, the average hydraulic diameter of the perforations can be in a range of not less than about 0.1 inches (0.254 cm), such as not less than about 0.2 inches (0.508 cm), or not less than about 0.3 inches (0.762 cm). The hydraulic diameter can be within a range comprising any pair of the previous upper and lower limits. In a particular embodiment, the hydraulic diameter can be in a range of not less than about 0.1 inches (0.254 cm) to not greater than about 2.0 inches (5.08 cm), such as not less than about 0.35 inches (0.889 cm) to not greater than about 1.0 inches (2.54 cm).

The spacing between adjacent perforations (i.e., the wall thickness) on surface the thermal energy storage body is notable and can be useful, alone or in conjunction with the hydraulic diameter of the perforations, to characterize certain dimensional and structural features of the thermal energy storage unit, particularly with regard to the thermal energy storage body and the cavity-creating element. The wall thickness between the individual perforations can be uniform or varying, the same or different. In an embodiment, the average ratio of hydraulic diameter to minimum wall thickness (D_{Havg}/Thk) can be in a range of not greater than about 3.0, such as not greater than about 2.8, not greater than about 2.6, not greater than about 2.4, not greater than about 2.2, not greater than about 2.0, or not greater than about 1.9. In an embodiment, the average ratio of hydraulic diameter to minimum wall thickness (D_{H}/Thk) can be in a range of not less than about 0.3, such as not less than about 0.4, or not less than about 0.5. The average ratio of hydraulic diameter to minimum wall thickness (D_{Havg}/Thk) can be within a range comprising any pair of the previous upper and lower limits. In a particular embodiment, the average ratio of hydraulic diameter to minimum wall thickness (D_{H}/Thk) can be in a range of not less than about 0.5 to not greater than about 3.0.

The perforations on the top or bottom surface of a thermal energy storage body can be arranged arbitrarily (e.g. randomly), or deliberately, in a myriad of patterns. The pattern of the perforations on the top surface can be the same or different as the pattern on the bottom surface. In an embodiment, a pattern of perforations can be any pattern having a uniform distribution, a non-uniform distribution, or a controlled non-uniform distribution. In another embodiment, a pattern of perforations can include: an array of vertical (as shown in FIG. 4A), diagonal (as shown in FIG. 4B), or horizontal rows and columns; a radial pattern (as shown in FIG. 4C), a spiral pattern, a phyllotactic pattern, a symmetric pattern, an asymmetric pattern, or combinations thereof. The pattern can cover (i.e., be distributed over) the entire top or bottom surface of the thermal energy storage body, can cover substantially the entire top or bottom surface of the thermal energy storage body (i.e. greater than 50% but less than 100%), can cover multiple portions of the top or bottom surface of the thermal energy storage body, or can cover only a portion of the top or bottom surface of the thermal energy storage body.

The perforations on the top and bottom surfaces of the thermal energy storage body can define the shape of the passages that extend through the thermal energy storage body. The cross-sectional shape of the passages can be the same or different from each other. The cross-sectional shape of the passages can be uniform, irregular, varying, or any combination thereof, as the passage extends through the thermal energy storage body. In an embodiment, the passages have a uniform cross-sectional shape that is the same as the shape of the perforation on the top surface to which the passage is connected. In another embodiment, the cross-sectional shape of the passages changes as the passage extends through the thermal energy storage body.

In an embodiment, any particular passage connects at least one perforation on the top surface of the thermal energy storage body to at least one perforation on the bottom surface of the thermal energy storage body. The path of the passages can be non-torturous, tortuous, or combinations thereof. In an embodiment, one or more of the passages is tortuous (i.e., irregular, that is, having a shape through the thermal energy storage body that includes curves and turns and is, therefore, not straight) In another embodiment, one or more of the passages is non-tortuous (i.e., substantially straight) through the thermal energy storage body.

The perforations define the open face area of the top surface or bottom surface of the thermal energy storage body. Similarly, the passages define a void volume of the thermal energy storage body as the passages pass through the thermal energy storage body. In an embodiment, the open face area of the top or bottom surface of the thermal energy storage body is in a range of not greater than about 38%, such as not greater than about 37%, not greater than about 36%, or not greater than about 35%. In an embodiment, the open face area of the top or bottom surface of the thermal energy storage body can be in a range of not less than about 7%, such as not less than about 8%, not less than about 9%, or not less than about 10%. The open face area of the top or bottom surface of the thermal energy storage body can be can be within a range comprising any pair of the previous upper and lower limits. In a particular embodiment, the open face area of the top or bottom surface of the thermal energy storage body can be in a range of not less than about 10% to not greater than about 35%.

Similar to the open face area, in an embodiment, the void volume of the thermal energy storage body can be in a range of not greater than about 38%, such as not greater than about 37%, not greater than about 36%, or not greater than about 35%. In an embodiment, the void volume of the thermal energy storage body can be in a range of not less than about 7%, such as not less than about 8%, not less than about 9%, or not less than about 10%. The void volume of the thermal energy storage body can be can be within a range comprising any pair of the previous upper and lower limits. In a particular embodiment, the void volume of the thermal energy storage body can be in a range of not less than about 10% to not greater than about 35%.

The thermal energy storage unit includes a mixing cavity-creating element. The function of the mixing cavity-creating element is to create a mixing cavity, or continuous space, between two thermal energy storage bodies (i.e., a first thermal energy storage body and a second thermal energy storage body) that separates the opposing surfaces of the thermal energy storage bodies when they are placed adjacent to each other. Heat transfer fluid flowing through the various passages of the first thermal energy storage body is allowed to comingle, or mix, within the mixing cavity between adjacent bodies, which promotes temperature equalization and reduces the opportunity for any individual portion of the heat transfer fluid to have a temperature significantly above or below the average temperature of other portions of heat transfer fluid passing through the thermal energy storage body, thereby also reducing the opportunity for “hot-spots” to develop.

In an embodiment, the mixing cavity-creating element is integral to the thermal energy storage body. In another embodiment, the mixing cavity-creating element is external to the thermal energy storage body. In an embodiment, an external mixing cavity-creating element is component, such as a spacer ring, that is separate from the thermal energy storage body. In another embodiment, an external mixing cavity-creating element is a component that is part of, or extends from the containment vessel in which the thermal energy storage body is disposed.

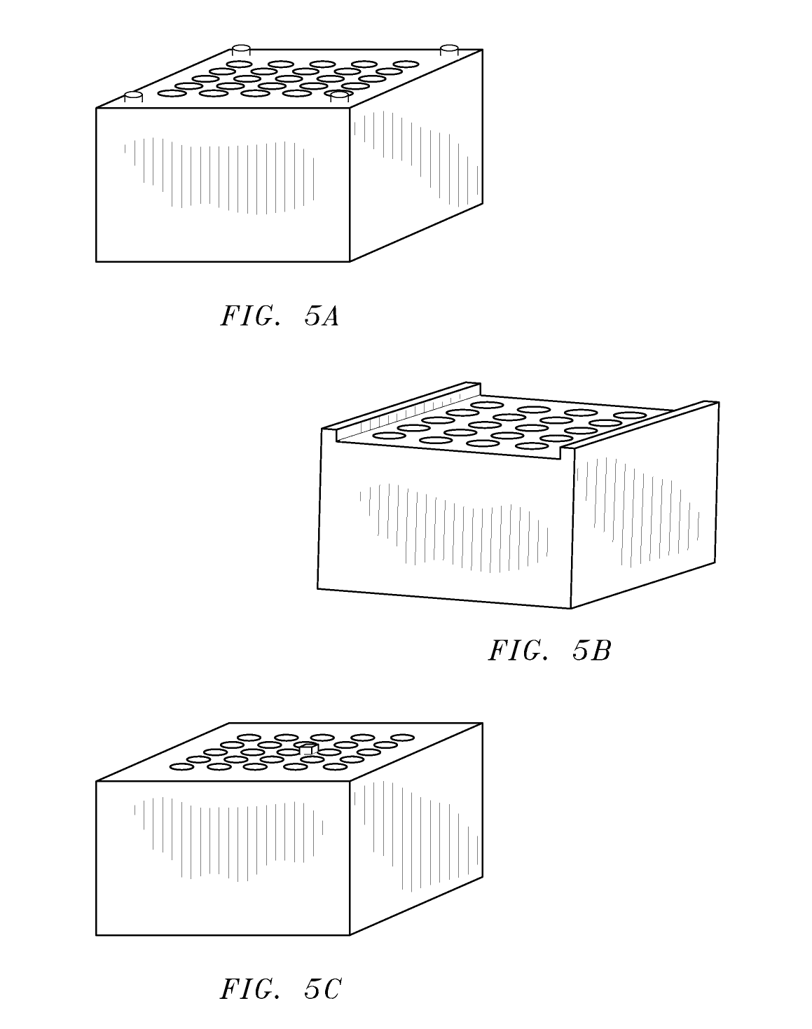

An integral mixing cavity-creating element can be integral to the top surface, the bottom surface, or both the top and bottom surfaces of the thermal energy storage body. For example, as shown in FIG. 1 and FIG. 5A-5C, an integral mixing cavity-creating element can be formed or molded on the top surface, the bottom surface, or both. In an embodiment, an integral mixing cavity-creating element can be a protrusion that extends orthogonally from either or both of the top or bottom surfaces of the thermal energy storage body. In another embodiment, the mixing cavity-creating element can be a plurality of integral protrusions that extend from either or both of the top or bottom surfaces of the thermal energy storage body.

A protrusion can take any shape or form that does not obstruct the perforations on the surface of the thermal energy storage body. A protrusion can be regular or irregular. A protrusion can have a continuous or discontinuous shape. A protrusion can be located anywhere on the top or bottom surface of the thermal energy storage body. In an embodiment, a protrusion can be a raised solid body, such as a polygonal prism, frusta, dome, or combinations thereof. In an embodiment, a protrusion can be a strip, lip, wall, mound, or combinations thereof.

In an embodiment, at least one protrusion can take the form of a strip. In an embodiment, a strip can be straight, curved, winding, angled, or combinations thereof. In an embodiment, a strip can extend between adjacent perforations. In an embodiment, a strip can surround one or more perforations. In an embodiment, one or more strips can intersect.

In an embodiment, the protrusion is a lip that extends radially about the periphery of the top surface of the thermal energy storage body.

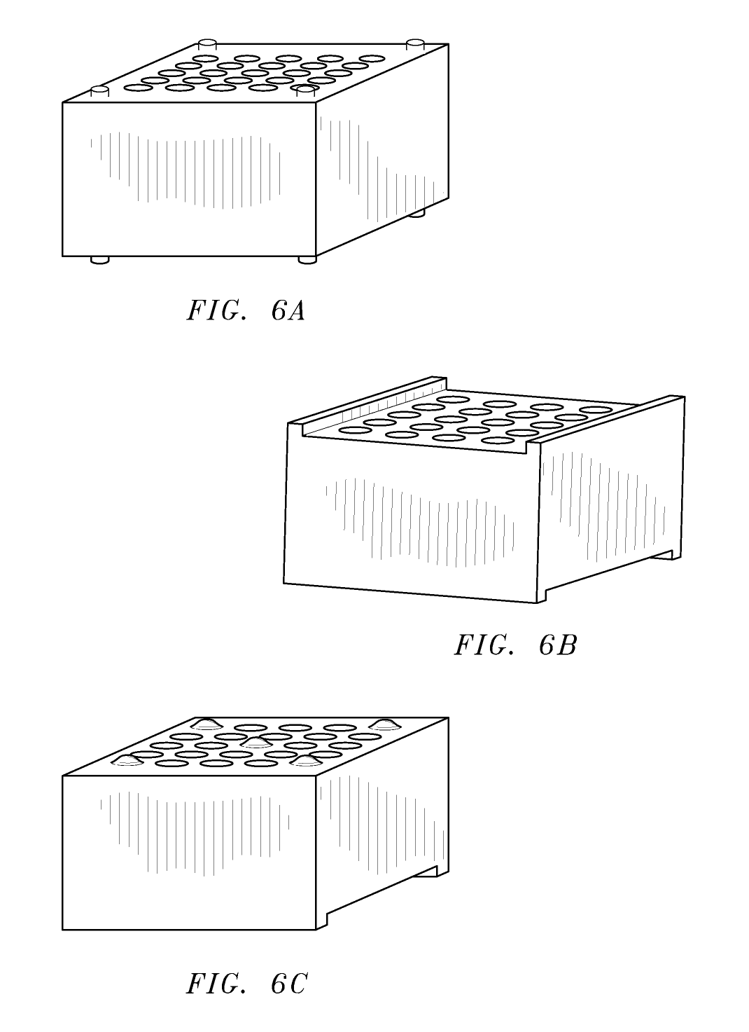

FIG. 1 shows an integral element, top surface, continuous lip or wall along periphery of the top surface of a thermal energy storage body. FIG. 5(A) shows raised solid bodies at four corners of the top surface of a thermal energy storage body. FIG. 5(B) shows two strips along the top surface of a thermal energy storage body. 5(C) shows a single raised square body in the middle of the top surface of a thermal energy storage body. FIG. 6A-6C show cavity creating elements on both the top and bottom surface of a thermal energy storage body.

A protrusion from the top surface of one thermal energy storage body can be formed to interlock with, or complement in shape, a protrusion from the bottom surface of an overlying adjacent thermal energy storage body. In an embodiment, a protrusion on the top surface of a thermal energy storage body can be in the shape of a semi-circle, while a protrusion on the bottom surface of an overlying adjacent thermal energy storage body can have a complimentary shaped semi-circle, such that when one body is placed above the adjacent body, the semi-circles interlock or complement a substantially complete circle.

The height of a mixing cavity-creating element is notable and affects the size of a mixing cavity, or mixing cavities, created between adjacent thermal energy storage bodies. The height of a mixing cavity-creating element is related to the desired height of a mixing cavity, as well as the hydraulic diameter of the perforations on the top or bottom surface of the thermal energy storage body. The height of a singular protrusion, or the sum of multiple protrusions that are stacked upon each other can define the height of the mixing cavity between adjacent thermal energy storage bodies. However, the height of the mixing cavity, and thus, the total height of any mixing cavity-creating elements, singular or as a sum total, is not greater than the average hydraulic diameter (D_{Havg}) of the perforations on the top surface of the thermal energy storage body, such as not greater than about 0.9 D_{Havg}, not greater than about 0.8 D_{Havg}, not greater than about 0.7 D_{Havg}, or not greater than about 0.6 D_{Havg}. In an embodiment, the total height of any mixing cavity-creating elements, singular or as a sum total, is not less than about 0.1 D_{Havg}, such as not less than about 0.2 D_{Havg}, not less than 0.3 D_{Havg}, or not less than about 0.4 D_{Havg}. The total height of any mixing cavity-creating elements, singular or as a sum total, can be within a range comprising any pair of the previous upper and lower limits. In a particular embodiment, the total height of any mixing cavity-creating elements, singular or as a sum total, can be in a range of about ⅓ to 1 times the D_{Havg} of the perforations on the top surface of the thermal energy storage body.

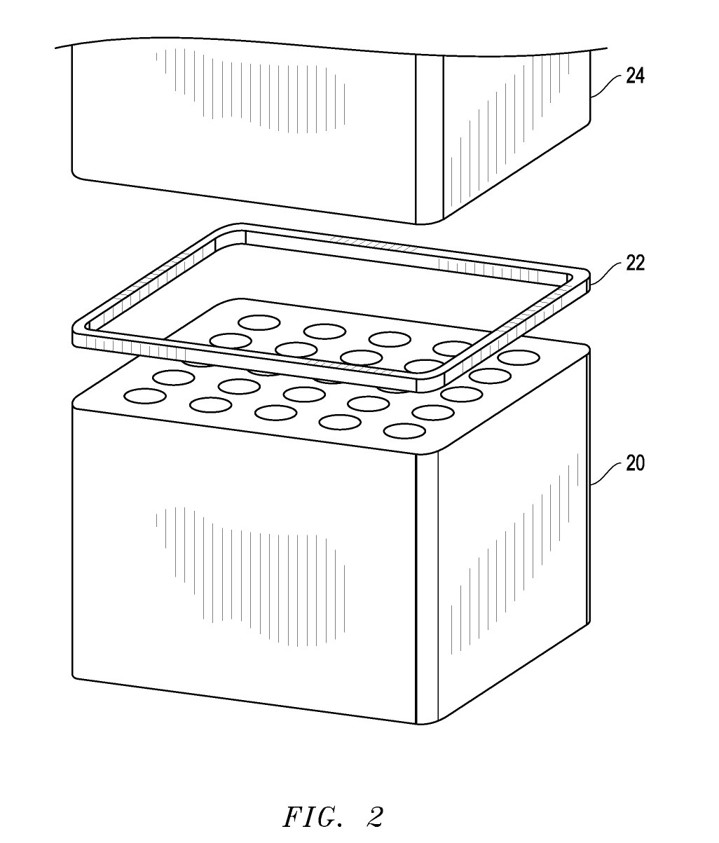

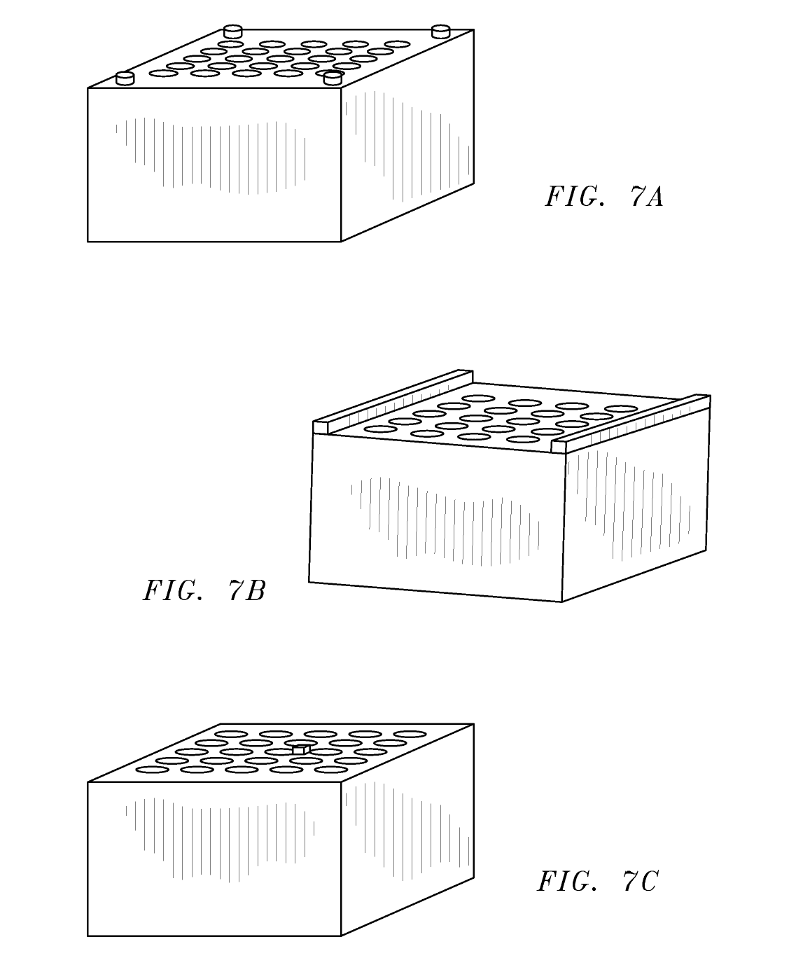

As mentioned previously, the mixing cavity-creating element can be a separable element (i.e., an external element) from the top surface of the thermal energy storage body. In an embodiment, an external cavity-creating element can be an annular body, such as an annular ring (example shown in FIG. 7A-7C). An annular ring can be a circular ring, a square ring, a polygonal ring, or other shaped ring, such as a shape that matches the perimeter of the top surface of the thermal energy storage body (example shown in FIG. 2.). In a particular embodiment the annular ring can be a spacer ring, spacer flange, spacer gasket, or the like. In an embodiment, the external cavity-creating element can be a single annular body or a plurality of annular bodies disposed overlying each other. As discussed previously above, the mixing cavity has a height in a range of about ⅓ to 1 times the average hydraulic diameter (D_{Havg}) of the perforations on the top surface of the thermal energy storage body, therefore the total height of an external annular body, or the sum total of multiple annular bodies, will also be in a range of about ⅓ to 1 times the average hydraulic diameter (D_{Havg}) of the perforations on the top surface of the thermal energy storage body.

In another embodiment, an external mixing cavity-creating element can be a protrusion, a body, or a member, such as a support member, that extends from an interior surface of a containment vessel in which one or more of the thermal energy storage bodies are disposed. In an embodiment, a containment vessel can include a support member, such as a shelf, upon which a thermal energy storage body can rest, the support member separating an upper thermal energy storage body from an adjacent lower thermal energy storage body by a distance that defines the mixing cavity between the thermal energy storage bodies. In a specific embodiment, the support member can be a shelf made of angle iron.

In an embodiment, a thermal energy storage module comprises: a containment vessel; at least a first and second thermal energy storage body, each of the thermal energy storage bodies having a top surface, a bottom surface, a plurality of perforations that form passages that extend through from the top surface to the bottom surface, and a void volume of the thermal energy storage bodies in a range of about 10% to about 35%; a mixing cavity-creating element; and at least one continuous mixing cavity, wherein the first and second thermal energy storage body are disposed within the containment vessel and are positioned in series with the top surface of the first thermal energy storage body opposing the bottom surface of the second thermal energy storage body, wherein the mixing cavity-creating element is positioned between the top surface of the first thermal energy storage body and the bottom surface of the second thermal energy storage body, and wherein the at least one continuous mixing cavity is defined by the space between the top surface of the first thermal energy storage body and the bottom surface of the second thermal energy storage body.

The thermal energy storage module has a notable void volume that affects the thermal energy heat storage properties of the module and includes the void volume of each of the abutting thermal energy storage bodies as well as the continuous mixing cavity that is present between the abutting thermal energy storage bodies. The total void volume for the thermal energy storage module can be not greater than about 40%, such as not greater than about 38%, not greater than about 34%, not greater than about 30%, not greater than about 28%, not greater than about 24%, or not greater than about 22%. In an embodiment, the total void volume for the thermal energy storage module can be not less than about 8%, such as not less than about 9%, or not less than about 10%. The total void volume for the thermal energy storage module can be within a range comprising any pair of the previous upper and lower limits. In a particular embodiment, the total void volume for the thermal energy storage module can be in a range of about 10% to about 40%.

The thermal energy storage bodies and mixing cavity-creating element that comprise the thermal energy storage module can be as described above in relation to a thermal energy storage unit. In an embodiment, the perforations of the thermal energy storage bodies can be fully aligned with each other. In an embodiment, the cavity-creating element deliberately separates the top surface of the first thermal energy storage body from the bottom surface of the second thermal energy storage body by a distance ranging from ⅓ to 1 times the average hydraulic diameter of the perforations of the top surface of the first thermal energy storage body. In an embodiment, the annular ring can be integral or separable from the thermal energy storage body. In another embodiment, the cavity-creating element can be an integral or separable protrusion that extends from either the top surface of the first thermal energy storage body or the bottom surface of the second thermal energy storage body.

The thermal energy storage module may further comprise a heat transfer fluid. The heat transfer fluids included will be determined based on the particular application and operating conditions of the heat collection and storage system under consideration. In an embodiment, the heat transfer fluid will be an organic liquid, such as an oil. In a particular embodiment, the oil can be a mineral oil, such as a mixture of paraffins and napthenes, high purity white mineral oil, mixtures of diphenyl-oxide and biphenyl, mixtures of diphenyl oxide and 1,1-diphenylethane, a modified terphenyl, any combinations thereof, and the like.

In an embodiment, a thermal energy storage system comprises a plurality of the thermal energy storage modules that are disposed within one or more enclosures.

It will be appreciated that various aspects of the thermal energy storage bodies, mixing cavity-creating elements, and containment vessels described herein can be manipulated so as to provide a method of controlling the flow of a heat transfer fluid within a containment vessel.

In an embodiment, a method of controlling the flow of a heat transfer fluid within a containment vessel comprises: directing the heat transfer fluid through a first thermal energy storage body that is disposed within the containment vessel and that has a cross-section matching the interior dimensions of the containment vessel; wherein the heat transfer fluid flows through a plurality of perforations that form passages that extend through the first thermal energy storage body from a front face of the first thermal energy storage body to a back face of the first thermal energy storage body; directing the heat transfer fluid to collect within a cavity having a volume defined by the cross-sectional area of the back face of the first thermal energy storage body and an orthogonal distance from the back face of the first thermal energy storage body to the front face of a second thermal energy storage body that is disposed within the containment vessel and is substantially similar to the first thermal energy storage body; and causing the heat transfer fluid to flow through the second thermal energy storage body, wherein the orthogonal distance is equal to an average hydraulic diameter of the perforations of the back surface of the first thermal energy storage body, and wherein each of the first and second ceramic bodies have a void volume that is less than 35%. As described above, it will be recognized that usage of the terms “front face” and “back face” is synonymous with the terms “top surface” and “back surface”, respectively, in relation to the thermal energy storage body.

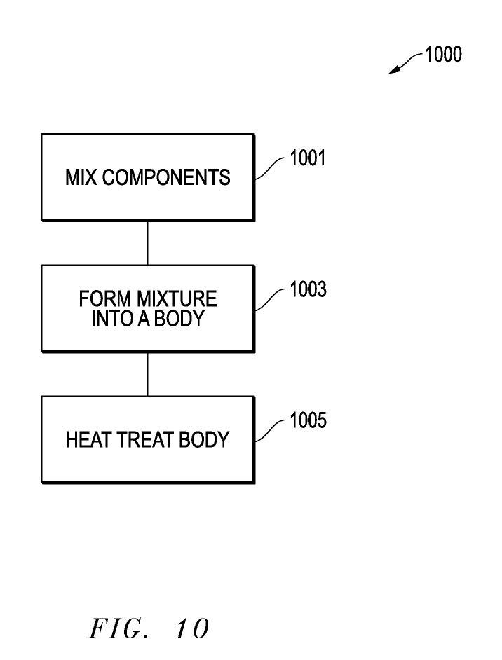

FIG. 10 shows a particular embodiment of a method 1000 of making a thermal energy storage unit. The process is initiated at activity 1001 by mixing together ceramic components, including iron oxide, to form a ceramic mixture. In activity 1003, the ceramic mixture is formed into a thermal energy storage body having an integral mixing cavity-creating element. In activity 1005, the thermal energy storage body is heat treated to form a thermal storage unit.

A thermal energy storage body can be formed from any material that provides sufficient structural strength, has sufficient thermal energy storage capacity, and that is compatible with an intended heat transfer fluid, as well as, any other chemicals, compounds, or other materials that will be in contact with the thermal energy storage body. In an embodiment, the body can be formed from metal material, ceramic material, cermet material, vitreous material, polymer material, composite material, or combinations thereof. In an embodiment, the metal material can be iron, cast iron, carbon steel, alloy steel, stainless steel, or combinations thereof. In an embodiment, the thermal energy storage body can be a ceramic thermal energy storage body formed from ceramic materials. In an embodiment, the ceramic material can be one of the group consisting of natural clays, synthetic clays, feldspars, zeolites, cordierites, aluminas, zirconia, silica, aluminosilicates, magnesia, iron oxide, titania, silicon carbide, cements, sillimanite, mullite, magnesite, chrome-magnesite, chrome ore, and mixtures thereof. In an embodiment, the clays can be mixed oxides of alumina and silica and can include materials such as kaolin, ball clay, fire clay, china clay, and the like. In certain embodiments, the clays are high plasticity clays, such as ball clay and fire clay. In a particular embodiment, the clay may have a methylene blue index, (“MBI”), of about 11 to 13 meq/100 gm. The term “feldspars” is used herein to describe silicates of alumina with soda, potash, and lime. Other ceramic materials, such as quartz, zircon sand, feldspathic clay, montmorillonite, nepheline syenite, and the like can also be present in minor amounts. In an embodiment, the ceramic material can include oxides, carbides, nitrides, and mixtures thereof of the following compounds: manganese, silicon, nickel, chromium, molybdenum, cobalt, vanadium, tungsten, iron, aluminum, niobium, titanium, copper, and any combination thereof.

External mixing cavity-creating components, can be formed from the same materials described above used to form thermal energy storage bodies.

In an embodiment, a composition for forming a thermal energy storage body can comprise an iron oxide powder composition comprising the following major ingredients in the given concentration ranges:

| | |
|---|---|
| Fe₂O₃ | about 59 wt % to about 98 wt % |
| SiO₂ | about 6 wt % to about 12 wt % |
| Al₂O₃ | about 2 wt % to about 5 wt % |
| MgO | about 0 wt % to about 2 wt % |
| CaO | about 0 wt % to about 1 wt % |
| MnO | about 0 wt % to about 1 wt % |
| Moisture | about 0 wt % to about 1 wt % |

It will be understood that the concentration of the major ingredients can be adjusted and that as the amount of one component is increased, one or more other components can be decreased so that a 100% weight percent composition is maintained. Additionally it will be recognized that the above composition is for the major ingredients and that trace amounts of other compounds can be present.

In an embodiment, a composition for forming a thermal energy storage body can comprise a clay composition comprising the following major ingredients in the given concentration ranges:

| | |
|---|---|
| SiO₂ | about 49 wt % to about 81 wt % |
| Al₂O₃ | about 22 wt % to about 38 wt % |
| Fe₂O₃ | about 1 wt % to about 2 wt % |
| MgO | about 0 wt % to about 1 wt % |
| TiO₂ | about 2 wt % to about 3 wt % |
| K₂O | about 0 wt % to about 1 wt % |

In an embodiment, a composition for forming a thermal energy storage body can comprise final composition comprising the following major ingredients in the given concentration ranges:

| | |
|---|---|
| Fe₂O₃ | about 48 wt % to about 80 wt % |
| SiO₂ | about 19 wt % to about 31 wt % |
| Al₂O₃ | about 6 wt % to about 10 wt % |
| MgO | about 1 wt % to about 1.3 wt % |
| CaO | about 0 wt % to about 1 wt % |
| MnO | about 0 wt % to about 3 wt % |
| TiO₂ | about 0 wt % to about 1 wt % |

A ceramic mixture can be formed into a thermal energy storage body by any suitable method known in the art that is capable of shaping the ceramic mixture so that it has the proper dimensions, void volume, and if desired, an integral mixing cavity creating element. Extrusion, molding, casting, pressing, and embossing are all acceptable methods of forming a ceramic thermal energy storage body.

External mixing cavity-creating components, can be formed by the same methods described above used to form thermal energy storage bodies.

Typically, the formed ceramic green body is heat treated, such as by calcining, sintering, or firing that alters the crystallite size, grain size, density, tensile strength, young's modulus, and the like of the ceramic material. Such heat treatment processes can generally be carried out in a temperature range, atmosphere, and pressure for a desired period of time that will depend upon the material composition of the green body. In an embodiment, a composition comprising iron oxide, etc. can be fired at a temperature in a range of about 1100-1300° C. for a time period of about between 15 minutes to 12 hours.

The properties and advantage of the present disclosure are illustrated in further detail in the following nonlimiting examples. Unless otherwise indicated, temperatures are expressed in degrees Celsius, pressure is ambient, and concentrations are expressed in weight percentages.

### EXAMPLE 1

### Making 80/20 Iron-Oxide/Clay Body Formulation

Eighty (80) lbs. of Iron-Oxide powder having the composition given below in Table 1 can be weighed out.

TABLE 1
Iron Oxide Powder Composition

| Major Ingredients | Weight % |
|---|---|
| Fe₂O₃ | 78.7% |
| SiO₂ | 9.0% |
| Al₂O₃ | 2.9% |
| MgO | 1.1% |
| CaO | 0.7% |
| MnO | 0.5% |
| Moisture | 0.5% |

Twenty (20) lbs. of Clay powder having the composition given in Table 2. can be weighed out.

TABLE 2

| Major Ingredients | Weight % |
|---|---|
| SiO₂ | 65.0% |
| Al₂O₃ | 30.0% |
| Fe₂O₃ | 1.2% |
| MgO | 0.18% |
| TiO₂ | 2.3% |
| K₂O | 0.35% |

Approximately 45 grams (about 0.1% of composition) of soap can be weighed out.

The Iron-Oxide powder, Clay powder, and soap can be mixed according to the manner below to make a composition suitable for forming: a thermal energy storage body, with or without an integral cavity-creating element, or an external cavity-creating element (e.g., spacer ring).

The Iron-Oxide powder and Clay powder can be dry-mixed together for 4 minutes using an R-08 mixer. Seven (7) lbs. (3.18 kg) of de-ionized water can be mixed into the mixture for 3 minutes. Another five (5) lbs. (2.27 kg) of de-ionized water plus the soap can be mixed into the mixture for 3 minutes. Another three (3) lbs. (1.36 kg) of de-ionized water can be mixed into the mixture for 3 minutes. Another two (2) lbs. (0.91 kg) of de-ionized water can be mixed into the mixture for 3 minutes.

The mixture will then be ready for the extrusion and forming of the blocks and have a total moisture content of around 17%. After forming of the blocks, they can be dried to less than 2% moisture and fired at 1180-1220° C. using a Tunnel kiln. Alternatively, they could be fired in another type of kiln, such as a gas, infrared, high-temperature, laboratory, periodic, pusher-type, roller hearth, or rotary kiln.

The composition of the final fired blocks will be as shown in Table 3.

TABLE 3

| Major Ingredients | Weight % |
|---|---|
| Fe₂O₃ | 64.0% |
| SiO₂ | 24.8% |
| Al₂O₃ | 8.0% |
| MgO | 1.0% |
| CaO | 0.5% |
| MnO | 0.4% |
| TiO₂ | 0.5% |

### EXAMPLE 2

### Thermal Heat Storage Unit-Cylindrical

Theoretical calculations are presented for two cylindrical bodies that can be made in accordance with Example 1 above, each having 55 perforations (and straight passages through the bodies) in a radial pattern, a void fraction of the body of 0.35 (35%) for each body, an open face area of 0.38 (38%), a body diameter of 6 inches (15.24 cm) and a length of 6 inches (15.24 cm); and a circular spacer ring (square cross section) of 0.25 inch (0.635 cm) thickness, 0.25 inch (0.635 cm) height, and 6 inch (15.24 cm) outer diameter.

The “open area” of the top face of each ceramic body was calculated to be [(pi*3 in.̂2)*0.35]=about 10.74 in.² (69.29 cm²). The average hydraulic diameter D_{H} of the perforations of the top face was calculated to be [2(sqrt(10.74 in.²/55)/pi)]=about 0.5 inches (1.27 cm). The height of the mixing cavity was calculated to be about 0.25 inches (0.635 cm). The volume of the mixing cavity (the volume within the inner circumference of the spacer) was calculated to be [pi*2.75 in.̂2*0.25 in]=about 5.94 in.³.(97.34 cm³) The total volume of the module (including the mixing cavity) was calculated to be [2(pi*3 in.̂2*6 in.)+(pi*3 in.̂2*0.25 in.)]=about 685.65 in.³ (11,225.14 cm³). The total void volume for the module (including the mixing cavity) was calculated to be [2(.38(pi*3 in.̂2*6 in.)+(pi*2.75 in.̂2*0.25 in.)]=about 263.80 in³ (4,322.91 cm³). The total void fraction of the module was calculated to be [263.80/685.65]=0.384.

### EXAMPLE 3

### Thermal Heat Storage Unit-Rectangular

Theoretical calculations are presented for two rectangular prism bodies that can be made in accordance with Example 1 above, each having 25 circular perforations (and straight passages through the bodies) arranged in a uniform array of 5 rows of 5 perforations per row (a 5×5 pattern), a void fraction of 0.20 (20%) for each body, an open face area of 0.20 (20%), a body length of 6 inches (15.24 cm), a width of 6 inches (15.24 cm), a length of 8 inches (20.32 cm); and a square spacer ring (square cross section) of 0.25 in. (0.635 cm) thickness and 6×6 in. (15.24×15.24 cm) outer dimensions. The ratio of hydraulic diameter to wall thickness (D_{H}/Thk) is 1.33. The spacing of the perforations is 1.44 to 1.5 holes per square inch (per 6.45 cm²).

The “open area” of the top face of each body was calculated to be [(6 in.×6 in.)0.20]=about 7.2 in² (46.45 cm²). The average hydraulic diameter D_{H} of the perforations of the top face was calculated to be [7.2 in.²/25]=about 0.288 in.² (1.86 cm²), and the average hole diameter was calculated to be [2(sqrt(7.2 in.²/25)/pi)]=about 0.6 inches (1.52 cm). The average minimum wall thickness was calculated to be 0.45 inches (1.14 cm). The ratio of hydraulic diameter to wall thickness (D_{H}/Thk)=[0.6/.45]=1.33. The height of the mixing cavity was calculated to be about 0.3 inches (0.762 cm). The volume of the mixing cavity (minus the area of the spacer with height of 0.3, and width of 0.3) was calculated to be [(0.3 in.*6 in.*6 in.)−(0.3 in.*0.3 in.*6 in.)2+(0.3 in.*0.3 in.*5.4 in.)2]=10.8 in.³−2.052 in³=about 8.74 in³ (143.22 cm³). The total volume of the module (including both bodies and the mixing cavity) was calculated to be [10.8+2(6 in.*6 in.*8 in.)]=586.8 in³ (9,615.92 cm³). The total void volume for the module (including both bodies and the mixing cavity) would be =[2(7.2*8)+8.74]=123.94 in³ (2,031.01 cm³). The total void fraction of the module =[123.94/586.8]=0.211.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A thermal energy storage unit, comprising:
a thermal energy storage body having a top surface, a bottom surface, a plurality of perforations that form passages extending through the thermal energy storage body from the top surface to the bottom surface, a void volume in a range of about 10% to about 35%; and
a mixing cavity-creating element.

2. The thermal energy storage unit of claim 1, wherein the thermal energy storage body has a ratio (D_{Havg}/Thk_{avg}) ranging from about 0.5 to about 3.0,
wherein D_{Havg} is the average hydraulic diameter of the perforations and Thk_{avg} is the average narrowest wall thickness between adjacent perforations.

3. The thermal energy storage unit of claim 1, wherein the top surface of the thermal energy storage body has a total open face area in a range of about 10% to about 35%.

4. The thermal energy storage unit of claim 1, wherein the perforations and passages of the thermal energy storage body have a uniform cross-sectional shape.

5. The thermal energy storage unit of claim 1, wherein the perforations have a hydraulic diameter in the range of about 0.2 inch (5.08 mm) to about 1.2 inch (30.48 mm).

6. The thermal energy storage unit of claim 1, wherein the perforations have a circular shape.

7. The thermal energy storage unit of claim 1, wherein the perforations are arranged in a pattern comprising a plurality of rows.

8. The thermal energy storage unit of claim 1, wherein the perforations are arranged in a radial pattern that extends from the center of the top surface to the periphery of the top surface.

9. The thermal energy storage unit of claim 1, wherein the perforations are spaced apart at a distance ranging from about 1 to about 2 complete perforations per square inch (6.452 square cm).

10. The thermal energy storage unit of claim 1, wherein the passages have a non-tortuous path.

11. The thermal energy storage unit of claim 1, wherein the passages have an entrance hydraulic diameter that is different from the exit hydraulic diameter.

12. The thermal energy storage unit of claim 1, wherein the thermal energy storage body and mixing cavity-creating element are adapted to fit within a containment vessel.

13. The thermal energy storage unit of claim 9, wherein the thermal energy storage body has a cross-sectional area matching the interior cross-section of the containment vessel.

14. The thermal energy storage unit of claim 1, wherein the mixing cavity-creating element is integral with the top surface of the thermal energy storage body.

15. The thermal energy storage unit of claim 14, wherein the mixing cavity-creating element comprises at least one protrusion that extends upward from the top surface of the thermal energy storage body.

16. The thermal energy storage unit of claim 15, wherein the at least one protrusion has a height in a range from about 1 to about ⅓ of the average hydraulic diameter of the perforations on the top surface of the thermal energy storage body.

17. The thermal energy storage unit of claim 16, wherein the at least one protrusion is a discontinuous lip that extends radially about the periphery of the top surface of the thermal energy storage body.

18. The thermal energy storage unit of claim 16, wherein the at least one protrusion is a continuous strip that extends along a portion of the top face of the thermal energy storage body and between at least two adjacent perforations.

19. The thermal energy storage unit of claim 1, wherein the mixing cavity-creating element is a separable element from the top surface of the thermal energy storage body.

20. The thermal energy storage unit of claim 19, wherein the mixing cavity-creating element is an annular body that extends radially about the periphery of the top surface of the thermal energy storage body.

21. The thermal energy storage unit of claim 13, wherein the mixing cavity-creating element extends from an interior surface of the containment vessel.

22. The thermal energy storage unit of claim 21, wherein the mixing cavity-creating element is a support member that extends from an interior surface of the containment vessel.

23. The thermal energy storage unit of claim 1, wherein the thermal energy storage body is a unitary member.

24. The thermal energy storage unit of claim 1, wherein the thermal energy storage body comprises a plurality of pieces that fit together to form the thermal energy storage body.

25. The thermal energy storage body of claim 24, wherein the plurality of pieces comprise a single layer.

26. The thermal energy storage body of claim 24, wherein the plurality of perforations and passages are formed by adjoining edges of the plurality of pieces when the plurality of pieces is assembled.

27. The thermal energy storage unit of claim 24, wherein the plurality of pieces are pie-shaped wedges.

28. The thermal energy storage unit of claim 24, wherein the plurality of pieces comprise concentric shapes.

29. The thermal energy storage unit of claim 1, wherein the thermal energy storage body comprises one of the group consisting of natural clays, synthetic clays, feldspars, zeolites, cordierites, aluminas, zirconia, silica, aluminosilicates, magnesia, iron oxide, titania, silicon carbide, cements, and mixtures thereof.

30. The thermal energy storage unit of claim 14, wherein the thermal energy storage body comprises about 10 wt % to about 95 wt % of iron oxide.

31. A thermal energy storage module, comprising:
a containment vessel;
at least a first and second thermal energy storage body, each of the ceramic bodies having a top surface, a bottom surface, a plurality of perforations that form passages that extend through from the top surface to the bottom surface, and a void volume in a range of about 10% to about 35%;
a mixing cavity-creating element; and
at least one continuous mixing cavity;
wherein the first and second thermal energy storage body are positioned in series with the top surface of the first thermal energy storage body opposing the bottom surface of the second thermal energy storage body,
wherein the mixing cavity-creating element is positioned between the top surface of the first thermal energy storage body and the bottom surface of the second thermal energy storage body,
wherein the at least one continuous mixing cavity is defined by the space between the top surface of the first thermal energy storage body and the bottom surface of the second thermal energy storage body.

32. The thermal energy storage module of claim 31 having a total void volume, including the continuous mixing cavity, in a range from about 10% to about 40%.

33. The thermal energy storage module of claim 31, wherein the cavity-creating element deliberately separates the top surface of the first thermal energy storage body from the bottom surface of the second thermal energy storage body by a distance ranging from ⅓ to 1 times the average hydraulic diameter of the perforations of the top surface of the first thermal energy storage body.

34. The thermal energy storage module of claim 31, wherein the cavity-creating element is an annular ring that separates the at least first and second ceramic bodies.

35. The thermal energy storage module of claim 31, wherein the cavity-creating element is a protrusion that extends from either the top surface of the first thermal energy storage body or the bottom surface of the second thermal energy storage body.

36. The thermal energy storage module of claim 31, wherein the plurality of perforations of each thermal energy storage body are fully aligned.

37. The thermal energy storage module of claim 31, further comprising a heat transfer fluid.

38. A thermal heat storage system, comprising:
a plurality of thermal heat storage modules according to claim 33 that are disposed within an enclosure.

39. A method of making a thermal storage unit, comprising the steps of:
forming ceramic material into a thermal energy storage body;
forming voids in the thermal energy storage body, wherein the voids extend through the thermal energy storage body from a first surface of the thermal energy storage body to a second surface of the thermal energy storage body and the thermal energy storage body has a void volume between 10% and 35%;
forming, or disposing, a mixing cavity-creating element onto the first or second surface of the thermal energy storage body.

40. The method of claim 39, wherein the step of forming the voids includes forming voids that comprise 35% or less of the surface area of the first or second surface of the body.

41. The method of claim 39, wherein the step of forming or disposing a cavity-creating element includes forming one or more protrusions on the first or second side of the thermal energy storage body.

42. The method of claim 41, wherein the step of forming the one or more protrusions includes forming one or more protrusions having a height of no greater than the average hydraulic diameter of the voids.

43. The method of claim 41, wherein the step of forming or disposing a cavity-creating element includes forming an integral annular ring on the first or second side of the thermal energy storage body.

44. The method of claim 43, wherein the step of forming the annular ring includes forming an annular ring having a height of no greater than the average hydraulic diameter of the voids.

45. A method of making a thermal storage module, comprising the steps of:
forming two or more ceramic bodies from ceramic material;
forming voids in the two or more ceramic bodies, wherein the voids extend through the ceramic bodies from a first surface of the ceramic bodies to a second surface of the ceramic bodies and the ceramic bodies have a void volume ranging from 10% to 35%;
positioning the two or more ceramic bodies within a container, wherein positioning the two or more ceramic bodies within the container includes positioning a cavity-creating element between the two or more thermal storage bodies such that a continuous mixing cavity is formed and the thermal storage module has a void volume in a range of about 10% to 40%.

46. A method of controlling the flow of a heat transfer fluid within a containment vessel, comprising:
directing the heat transfer fluid through a first thermal energy storage body that is disposed within the containment vessel and that has a cross-section matching the interior dimensions of the containment vessel;
wherein the heat transfer fluid flows through a plurality of perforations that form passages that extend through the first thermal energy storage body from a front face of the first thermal energy storage body to a back face of the first thermal energy storage body;
directing the heat transfer fluid to collect within a cavity having a volume defined by the cross-sectional area of the back face of the first thermal energy storage body and an orthogonal distance from the back face of the first thermal energy storage body to the front face of a second thermal energy storage body that is disposed within the containment vessel and is substantially similar to the first thermal energy storage body; and
causing the heat transfer fluid to flow through the second thermal energy storage body,
wherein the orthogonal distance is equal to an average hydraulic diameter of the perforations of the back surface of the first thermal energy storage body, and
wherein each of the first and second ceramic bodies have a void volume that is less than 35%.
